(19) United States
(12) Patent Application Publication
(10) Pub. No.: US 2005/0147883 A1
(43) Pub. Date: Jul. 7, 2005

(54) Electrolyte, negative electrode and battery

(76) Inventor: Tadahiko Kubota, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/506,921

(22) PCT Filed: Dec. 26, 2003
(86) PCT No.: PCT/JP03/16945

(30) Foreign Application Priority Data
Jan. 9, 2003 (JP) 2003-3772

(51) Int. Cl. H01M 4/60

(52) U.S. Cl. 429/213

(57) ABSTRACT

Provided are an electrolyte, an anode and a battery capable of improving the efficiency of precipitation and dissolution of Li, and cycle characteristics. A metal sheet (12A) which is made of Cu and does not contain Li is used as the anode (12) to deposit Li metal. An aromatic compound having an —OX group (X is H or alkali metal) such as catechol is added to an electrolytic solution (16) and a precipitation film (12C) is deposited on the surface thereof with Li metal in the initial charge. The precipitation film (12C) prevents a dendrite growth of Li and a reaction between Li and the electrolytic solution (16).

### TECHNICAL FIELD

The present invention relates to a battery comprising a cathode, an anode and an electrolyte, and to an electrolyte and an anode used in the battery.

### BACKGROUND ART

In recent years, as a power source for a portable device such as a cellular phone and a laptop personal computer, a small size secondary battery having a high energy density has been strongly demanded. As such a secondary battery, a battery using an alloy which form an intermetallic compound with lithium (Li) for an anode, or a battery using metal lithium for the anode to utilize a precipitation and dissolution reaction can be cited. A development of a secondary battery using a so-called lithium-free anode which is made of copper (Cu) nickel (Ni) or the like and includes no lithium to precipitate and dissolve lithium on the anode, and avoiding the use of metal lithium for the anode at the time of fabrication has been desired. Practical application of such a secondary battery can make the anode thinner and further improve energy density. In addition, no metal lithium having high activity is required in the manufacturing process, thereby the manufacturing process is simplified. This makes it possible to realize a combined process with an electronics device such as a circuit process.

However, in spite of examination of a lithium secondary battery accompanying the precipitation and dissolution reaction of metal lithium, there is a problem that it is difficult to put the secondary battery into practical use due to high discharge capacity degradation when repeating charge and discharge. In accordance with charge and discharge, the volume of the anode largely increases or decreases by the capacity corresponding to lithium ions which transfer between the cathode and the anode, so the volume of the anode changes significantly and a dissolution reaction and a recrystallization reaction of metal lithium crystal is hard to reversibly proceed. This results in the capacity degradation. In addition, the higher energy density the lithium secondary battery achieves, the more largely the volume of the anode is changed, and the more pronouncedly the capacity deteriorates. Furthermore, separation of the precipitated lithium or use of the precipitated lithium due to the reaction with the electrolyte may cause the capacity degradation. As a method to solve these problems, addition of additives to an electrolytic solution can be thought.

In the conventional secondary batteries, in order to improve characteristics, many batteries in which additives are added to the electrolytic solution have been developed. For example, a secondary battery wherein catechol is added to an electrolytic solution in order to improve cycle characteristics is cited (refer to Japanese Unexamined Patent Application Publication Nos. 2000-156245 and 2000-306601). A metal lithium secondary battery using a lithium metal sheet for an anode and adding catechol to an electrolytic solution is disclosed in Japanese Unexamined Patent Application Publication No. 2000-156245. A lithium ion secondary battery using carbon material for an anode and adding catechol to an electrolytic solution is disclosed in Japanese Unexamined Patent Application Publication No. 2000-306601. However, it is difficult for the metal lithium secondary battery disclosed in Japanese Unexamined Patent Application Publication No. 2000-156245 to sufficiently reduce the capacity degradation. Further, the reaction in the anode of the lithium ion secondary battery disclosed in Japanese Unexamined Patent Application Publication No. 2000-306601 differs completely from that of the metal lithium secondary battery.

### DISCLOSURE OF THE INVENTION

In view of the foregoing, it is an object of the invention to provide an electrolyte, an anode and a battery capable of improving battery characteristics such as cycle characteristics.

An electrolyte according to the invention comprises a precipitate which is formed when depositing metal on a metal sheet, which does not contain the metal to be deposited, in an electrolytic solution containing an aromatic compound having at least one kind from a hydroxyl group and a group in which hydrogen in a hydroxyl group is substituted with an alkali metal.

An anode according to the invention comprises a metal sheet which is a precipitation substrate for depositing metal and does not contain the metal to be deposited, and a precipitation film made of precipitate formed when depositing the metal on the metal sheet in an electrolytic solution containing an aromatic compound having at least one kind from a hydroxyl group and a group in which hydrogen in a hydroxyl group is substituted with an alkali metal.

A first battery of the invention comprises a cathode, an anode and an electrolyte. The electrolyte has a precipitate which is formed when depositing metal on a metal sheet, which does not contain the metal to be deposited, in an electrolytic solution containing an aromatic compound having at least one kind from a hydroxyl group and a group in which hydrogen in a hydroxyl group is substituted with an alkali metal.

A second battery of the invention comprises a cathode, an anode and an electrolyte. The anode comprises a metal sheet which is a precipitation substrate for depositing metal and does not contain the metal to be deposited and a precipitation film made of a precipitate which is formed when depositing the metal on the metal sheet in an electrolytic solution containing an aromatic compound having at least one kind from a hydroxyl group and a group in which hydrogen in a hydroxyl group is substituted with an alkali metal.

In the electrolyte of the invention, the precipitate prevents a side reaction and improves the battery characteristics.

In the anode of the invention, the precipitation film prevents the dendrite growth of metal. In addition, the side reaction caused by the deposited metal is prevented. Therefore, the capacity degradation is prevented and the efficiency of deposition and dissolution of the metal is improved.

In the first or second battery of the invention, the electrolyte or the anode of the invention is utilized. Therefore, the battery characteristics such as cycle characteristics are improved.

### BRIEF DESCRIPTION OF THE DRAWINGS

FIG. 1 is a sectional view showing a structure during fabrication of a secondary battery according to an embodiment of the invention;

FIG. 2 is a sectional view showing a structure of the secondary battery illustrated in FIG. 1 after charge;

FIG. 3 is an SEM photo after the initial charge according to example of the invention; and

FIG. 4 is an SEM photo after the initial charge according to comparative example of the invention.

### BEST MODE FOR CARRYING OUT THE INVENTION

Preferred embodiments of the invention will be described in more detail below referring to the accompanying drawings.

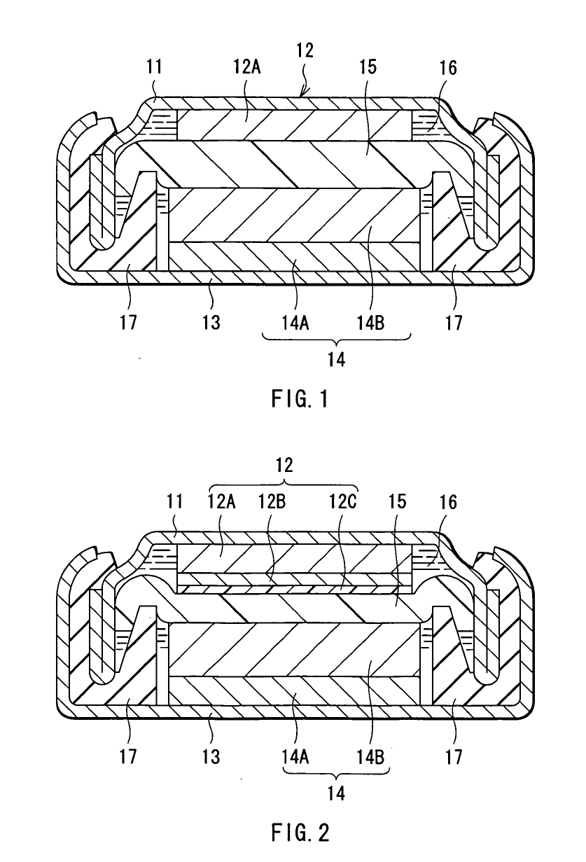

FIG. 1 and FIG. 2 show a structure of a secondary battery according to an embodiment of the invention. FIG. 1 shows a structure at the time of fabrication, that is, before the first (initial) charge and FIG. 2 shows a structure after charge. The secondary battery is a so-called coin type, and comprises a laminate including a disk-shaped anode 12 contained in a package cup 11 and a disk-shaped cathode 14 contained in a package can 13, which is a counter electrode of the anode 12, with a separator 15 in between. Inside the package cup 11 and the package can 13 are filled with an electrolytic solution 16, which is an electrolyte. Edge portions of the package cup 11 and the package can 13 are sealed through caulking by an insulating gasket 17. The package cup 11 and the package can 13 are made of, for example, metal such as stainless or aluminum (Al).

The anode 12 has, for example, a metal sheet 12A containing no lithium. The metal sheet 12A functions as a precipitation substrate for depositing metal lithium, which is a light metal, during charge and as a current collector. As a material for the metal sheet 12A, copper, nickel, titanium (Ti), molybdenum (Mo), tantalum (Ta), an alloy including at least one of them, and a metal material such as stainless which has a low reactivity with lithium are preferable. If using metal which has a high reactivity with lithium and easily alloy with lithium, the volume expands and shrinks according to charge and discharge, thereby the metal sheet 12A is destroyed.

As shown in FIG. 2, a metal lithium layer 12B and a precipitation film 12C are formed in this order during charge on the metal sheet 12A on a side facing the cathode 14. The metal lithium layer 12B is made of metal lithium and is absent during fabrication, and is dissolved when discharging. In other words, in the secondary battery, lithium is used as an anode active material and the capacity of anode 12 is represented by the capacity components by precipitation and dissolution of lithium.

The precipitation film 12C is made of the precipitate which is obtained when forming the metal lithium layer 12B on the metal sheet 12A in the electrolytic solution 16 containing an aromatic compound having at least one kind from a hydroxyl group and a group in which hydrogen in a hydroxyl group is substituted with an alkali metal and is formed on the surface of the metal lithium layer 12B. Hereinafter, the above-mentioned aromatic compound is called the aromatic compound having the —OX group. X represents hydrogen or an alkali metal, and hydrogen or lithium is preferable in the embodiment. The precipitation film 12C constitutes the anode 12 together with the metal sheet 12A and constitutes the electrolyte together with the electrolytic solution 16. The precipitation film 12C adsorb the electrolytic solution 16 and swell or allows lithium ions pass through minute holes in the precipitation film 12C. When fabricating the battery, there is no precipitation film 12C, but it remains on the metal sheet 12A after the initial charge.

For example, the aromatic compound having the —OX group has at least one kind from the group consisting of a hydroxyl group and a group in which hydrogen in a hydroxyl group is substituted with an alkali metal, and has at least one kind from the group consisting of the group in which a hydrogen atom and an alkyl group having a carbon number of 1 to 10 is preferable. In this aromatic compound having the —OX group, the former kind is bonded to aromatic ring at each of two positions where hydrogen atoms are bondable and the latter kind is bonded to aromatic ring at each of the remaining positions where hydrogen atoms are bondable. The aromatic ring includes not only a benzene ring or a condensed ring thereof but also a heterocycle group having aromaticity such as a pyridyl group. Examples of such an aromatic compound include catechol represented by Chemical Formula 1,3-methyl catechol represented by Chemical Formula 2,2,3-dihydroxy naphthalene represented by Chemical Formula 3,2,3-dihydroxy pyridine represented by Chemical Formula 4, a compound represented by Chemical Formula 5, hydroquinone represented by Chemical Formula 6,1,4-dihydroxy naphthalene represented by Chemical Formula 7,2,5-dimethyl hydroquinone represented by Chemical Formula 8 and resorcinol represented by Chemical Formula 9. As the aromatic compound having the —OX group, phenol, pyrogallol represented by Chemical Formula 10 and phloroglucinol represented by Chemical Formula 11 are also preferable. One or mixture of two or more kinds of aromatic compound having the —OX group can be used.

The cathode 14 has, for example, a structure in which a cathode current collector 14A and a cathode active material layer 14B are layered. The cathode current collector 14A is made of, for example, a metal foil such as an aluminum foil. The cathode active material layer 14B includes, for example, a cathode active material, a conductive agent such as carbon black and graphite and a binder such as polyvinylidene fluoride. The cathode active material layer 14B may be formed of a cathode material thin film deposited on the cathode current collector 14A, for example. It is preferable that the surface density of the cathode active material layer 14B is 0.3 mAh/cm² or more. If the surface density is smaller than that, it is impossible to obtain the high energy density, which is an advantage of the metal lithium secondary battery.

A lithium-containing compound such as a lithium transition metal oxide and a lithium-containing phosphate compound is preferable as the cathode active material, for example. There is no metal lithium in the anode 12 at the time of fabrication in the secondary battery, so the cathode active material containing lithium is preferable. Among them, a lithium transition metal complex oxide and a lithium-containing phosphate compound is preferable because they can obtain the high energy density.

The lithium transition metal complex oxide represented by chemical formula LiₓMO₂ is cited. In the chemical formula, M represents one or more kinds of transition metals, more specifically at least one kind selected from the group consisting of cobalt (Co), nickel, and manganese (Mn) is preferable. The value of x depends upon a charge-discharge state of the battery, and is generally within the range of 0.05≦x≦1.12. More specifically, LiCoO₂, LiNiO₂, Li_{y}Ni_{z}CO_{1-z}O₂ (the values of y and z depend upon a charge-discharge state of the battery, and are generally within the range of 0<y<1 and 0.7<z<1.02) and LiMn₂O₄ having a spinel structure are cited. LiFePO₄ is cited as a lithium-containing a phosphate compound.

The separator 15 separates the anode 12 and the cathode 14 and prevents short circuit of current due to the contact of both poles to let lithium ions pass through. The separator 15 is made of, for example, a porous film of a synthetic resin such as polytetrafluoroethylene, polypropylene, polyethylene or the like, or a porous film of an inorganic material such as ceramic nonwoven, and may have a structure in which two or more kinds of the porous films are laminated.

The electrolytic solution 16 contains a solvent and a lithium salt as an electrolyte salt. The solvent dissolves and dissociates the electrolyte salt. Examples of the solvent include propylene carbonate, ethylene carbonate, diethyl carbonate, methyl ethyl carbonate, 1,2-dimethoxyethane, 1,2-diethoxyethane, γ-butyrolactone, tetrahydrofuran, 2-methyltetrahydrofuran, 1,3-dioxolane, 4-methyl-1,3-dioxolane, diethyl ether, sulfolane, methylsulfolane, acetonitrile, propylnitrile, anisole, acetate, propionate and the like, and one kind or a mixture of two or more kinds selected from them may be used.

As the lithium salt, for example, LiClO₄, LiAsF₆, LiPF₆, LiBF₄, LiB(C₆H₅)₄, LiCH₃SO₃, LiCF₃SO₃, LiCl and LiBr are cited, and one kind or a mixture including two or more kinds selected from them may be used.

The electrolytic solution 16 contains the aromatic compound having the —OX bond before the initial charge and may contain it after the initial charge, but it is unnecessary to contain.

Instead of the electrolytic solution 16, an electrolyte holding the electrolytic solution in a support can be used. A high molecular weight compound, an inorganic conductor or both of them can be used as the support. Examples of high molecular weight compound include polyvinylidene fluoride, polyethylene oxide, polypropylene oxide, polyacrylonitrile and polymethacrylonitrile or a compound including these in a repeating unit and one kind or two or more kinds thereof can be used. Specifically, in terms of the stability of oxidation-reduction, fluorinated high molecular weight compounds are desirable. As the inorganic conductor, for example, lithium fluoride (LiF), lithium chloride (LiCl), lithium bromide (LiBr), lithium iodide (LiI), lithium nitride (Li₃N), lithium phosphate (Li₃PO₄), lithium silicate (Li₄SiO₄), lithium sulfide (Li₂S), lithium phosphide (Li₃P), lithium carbonate (Li₂CO₃) or lithium sulfate (Li₂SO₄) and lithium phosphoryl nitride (LiPON) are cited, and one kind or two or more kinds of them can be used. When using such an electrolyte, the separator 15 may be removed.

The secondary battery having such a structure can be manufactured as follow, for example.

First, a metal foil or an alloy foil is prepared as the metal sheet 12A. The cathode active material, the conductive agent and the binder are mixed to prepare a cathode mixture and the cathode mixture is applied to the cathode current collector 14A to form the cathode active material layer 14B. Thereby, the cathode 14 is formed. The cathode 14 may be formed by depositing the cathode active material layer 14B on the cathode current collector 14A by dry thin film process such as sputtering, vacuum deposition, CVD (Chemical Vapor Deposition), laser ablation or ion plating.

Next, the lithium salt and the aromatic compound having the —OX group are added to a solvent to form the electrolytic solution 16. After that, the separator 15 is impregnated with the electrolytic solution 16, and the anode 12 and the anode 14 are laminated with the separator 15 in between. The laminate is enclosed in the package cup 11 and the package can 13 and is caulked. Thereby, the secondary battery shown in FIG. 1 is completed.

In the secondary battery, when charged, for example, lithium ions are extracted from the cathode 14 and precipitated on the surface of the metal sheet 12A as metal lithium through the electrolytic solution 16 to form the metal lithium layer 12B, as shown in FIG. 2. At that time, the aromatic compound added to the electrolytic solution 16 in the fabrication forms the precipitation film 12C on the metal lithium layer 12B. On the other hand, when discharged, for example, metal lithium is extracted from the metal lithium layer 12B as metal lithium and inserted in the cathode 14 through the electrolytic solution 16 and the precipitation film 12C. Therefore, the precipitation film 12C prevents metal lithium from dendrite growth and from the reaction between the metal lithium layer 12B and the electrolytic solution 16.

As mentioned, the embodiment has the precipitation film 12C made of the precipitate which is formed during the formation of the metal lithium layer 12B on the metal sheet 12A in the electrolytic solution 16 containing the aromatic compound having the —OX group. Therefore, the dendrite precipitation of metal lithium can be prevented and the risk of short circuit can be reduced while preventing the separation of metal lithium. In addition, the reaction between the metal lithium layer 12B and the electrolytic solution 16 can be prevented. Thereby, the capacity degradation can be prevented and the efficiency of precipitation and dissolution can be improved. As a result, the battery characteristics such as cycle characteristics can be improved.

Next, specific examples of the invention will be described in more detail below referring to FIGS. 1 and 2.

First, a copper foil with a thickness of 10 μm was stamped into a disk shape with a diameter of 16 mm to form the metal sheet 12. The cathode 14 was formed as follows. For a start, lithium carbonate (Li₂CO₃) and cobalt carbonate (CoCO₃) were mixed at a molar ratio of 0.5:1, and the mixture was fired in air at 900° C. for five hours to obtain lithium cobalt complex oxide (LiCoO₂) as the cathode active material. Next, 91 parts by weight of lithium cobalt complex oxide, 6 parts by weight of graphite as an electronic conductor and 3 parts by weight of polyvinylidene fluoride as a binder were mixed to prepare a cathode mixture. Then, the cathode mixture was dispersed in N-methyl-2-pyrrolidone as a disperse medium to form cathode mixture slurry. After the cathode mixture slurry was uniformly applied to the cathode current collector 14A made of an aluminum foil with a thickness of 20 μm, dried, and compression-molded by a roller press so as to form the cathode active material layer 14B. After that, the cathode active material layer 14B was stamped into the disk shape with a diameter of 15 mm.

The electrolytic solution 16 was prepared by adding LiPF₆, which is a lithium salt, and 3-methyl catechol represented by Chemical Formula 2 to the solvent which obtained by mixing propylene carbonate and ethylene carbonate at a mass ration of 4:1. The amount of LiPF₆ was 1 mol/dm³ to the solvent and the amount of 3-methyl catechol was 1 wt % in the electrolytic solution 16.

Next, the anode 12 and the separator 15 formed of a porous film made of polypropylene were placed in the package cup 11 in this order, and then the electrolytic solution 16 was injected thereinto. The package can 13 including the cathode 14 was overlaid and caulked to form the coin-type secondary battery shown in FIG. 1.

As Comparative Example 1 relative to the example, a secondary battery was formed as in the case of the example, except that 3-methyl catechol was not added in the electrolytic solution 16 at the time of fabrication. As Comparative Example 2 relative to the example, a secondary battery was formed as in the case of the example, except that a metal lithium foil with a diameter of 16 mm and a thickness of 1 mm was used instead of the copper foil as the metal sheet 12A.

A charge-discharge test was conducted on the secondary batteries formed in the example and Comparative Examples 1 and 2 to obtain capacity retention ratio. At that time, charge was carried out at a constant current density of 1 mA/cm² until a battery capacity reached 5 mAh, and discharge was carried out at a constant current density of 1 mA/cm² until the battery voltage reached 3 V. The capacity retention ratio was calculated as a ratio of discharge capacity at 15th cycle with respect to the initial discharge capacity. The obtained results are shown in Table 1.

As can be seen from Table 1, in the example, the higher capacity retention ratio was obtained compared to Comparative Examples 1 and 2.

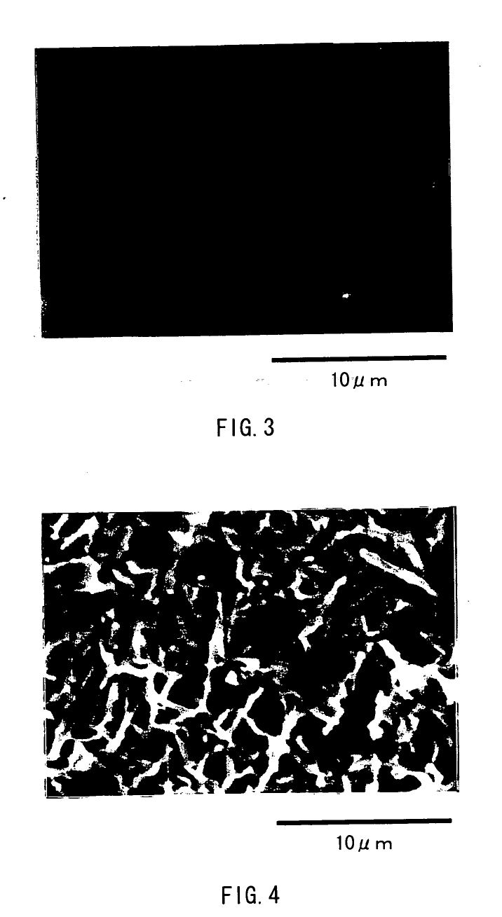

The secondary batteries obtained in the example and Comparative Examples 1 and 2 were charged under the above conditions and were disassembled to observe the anode 12. In the result, the presence of the precipitation film 12C was confirmed in the battery of the example. On the other hand, a metal lithium layer in which dendrites were condensed and no precipitation film were confirmed in the batteries of Comparative Examples 1 and 2. FIG. 3 shows an SEM (Scanning Electron Microscope) photo of the example and FIG. 4 shows an SEM photo of Comparative Example 2. Furthermore, the obtained secondary batteries of the example and Comparative Examples 1 and 2 were charged and discharged one cycle under the above conditions and then disassembled to analyze the electrolytic solution 16 with a proton nuclear magnetic resonance absorption method (¹H-NMR). In the result, as shown in Table 1, no 3-methyl catechol was confirmed in the electrolytic solution 16 of the example and Comparative Example 2. In other words, in the example, the precipitation film 12C was formed by 3-methyl catechol at the time of charge when metal lithium was precipitated. On the other hand, in Comparative Example 2, no precipitation film was formed because of the absence of 3-methyl catechol in the electrolytic solution at the time of charge when metal lithium was precipitated, since 3-methyl catechol and metal lithium in the anode reacted before charge.

More specifically, it was found out that if the precipitation film 12C which was formed during the formation of the metal lithium layer 12B on the metal sheet 12A containing no lithium in the electrolytic solution 16 containing 3-methyl catechol was included, the cycle characteristics could be improved.

The present invention is described referring to the embodiment and the example, but the invention is not limited to the above embodiment and the example, and is variously modified. For example, in the above embodiment and example, the aromatic compound having the —OX group was added to the electrolytic solution 16 and the precipitation film 12C was formed in the battery. However, the battery can be fabricated after forming the precipitation film on the metal sheet. In this case, the metal sheet on which the precipitation film was formed can be used, or only the precipitation film can be used.

Further, in the above embodiment and example, a single-layered secondary battery laminating the anode 12 and the cathode 14 is described. However, the invention can be applied to a wound type secondary battery in which the anode and the cathode are laminated and wound or to a laminate type secondary battery laminating a plurality of anodes and cathodes.

Furthermore, in the above embodiment and example, the coin type secondary battery is concretely described. However, the invention is applicable to a secondary battery with a coin shape, a button shape, a prismatic shape and other shape using the package member such as a laminate film. Further, the invention is applicable to not only the secondary batteries but also primary batteries.

In addition, in the above embodiment and example, lithium is used as an anode active material. The invention is applicable to the case where any other alkali metal such as sodium (Na) and potassium (K), alkali earth metal such as magnesium or calcium, any other light metal such as aluminum, lithium, or an alloy thereof is used, and the same effects can be obtained. In this case, the metal sheet, the cathode active material, the electrolyte salt or the like are selected according to the light metal.

As described, according to the electrolyte or the battery of the invention, a precipitate which is formed when depositing metal on a metal sheet, which does not contain the metal to be deposited, in an electrolytic solution containing an aromatic compound having at least one kind from a hydroxyl group and a group in which hydrogen in a hydroxyl group is substituted with an alkali metal is included. As a result, the precipitate prevents a side reaction and improves the battery characteristics such as cycle characteristics.

According to the anode or the battery of the invention, the precipitation film made of a precipitate which is formed when depositing metal on a metal sheet, which does not contain the metal to be deposited, in an electrolytic solution containing an aromatic compound having at least one kind from a hydroxyl group and a group in which hydrogen in a hydroxyl group is substituted with an alkali metal is included. This enables to prevent the dendrite deposition of metal. As a result, the risk of short circuit is reduced and the separation of the deposited metal is prevented. In addition, a side reaction caused by the deposited metal can be prevented. Therefore, the capacity degradation can be prevented and the efficiency of deposition and dissolution of the deposited metal can be improved.

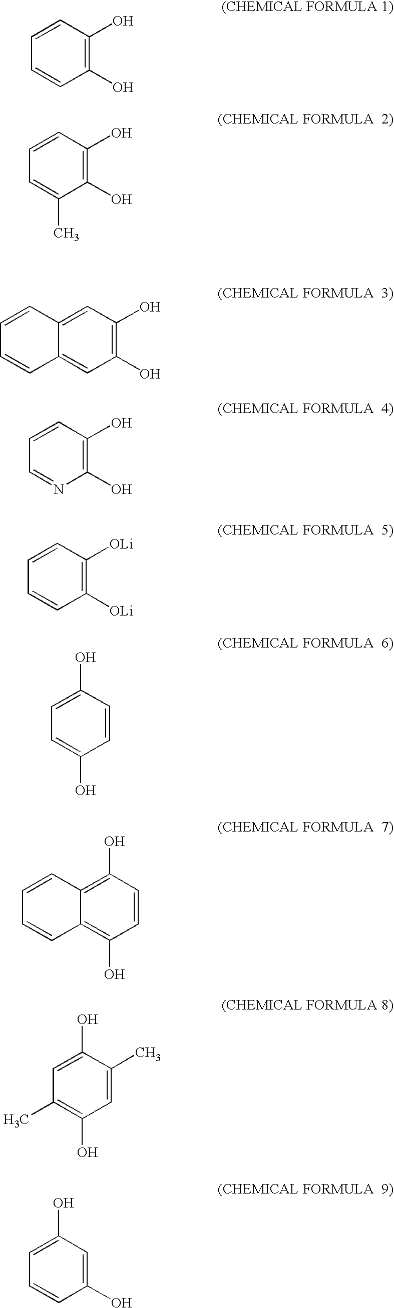

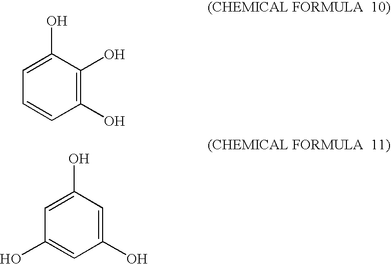

TABLE 1

| | | 3-METHYL | | | CAPACITY |
|---|---|---|---|---|---|
| | | CATECHOL | | | RETEN- |
| | MET- | BEFORE | AFTER | PRECIP- | TION |
| | AL | INITIAL | INITIAL | ITATION | RATIO |
| | SHEET | CHARGE | CHARGE | FILM | (%) |
| EXAMPLE | Cu | YES | NO | YES | 75 |
| COM- | Cu | NO | NO | NO | 68 |
| PARATIVE | | | | | |
| EXAMPLE | | | | | |
| 1 | | | | | |
| COM- | Li | YES | NO | NO | 69 |
| PARATIVE | | | | | |
| EXAMPLE | | | | | |
| 2 | | | | | |

1. An electrolyte comprising a precipitate which is formed when depositing metal on a metal sheet in an electrolytic solution containing an aromatic compound having at least one kind from a hydroxyl group and a group in which hydrogen in a hydroxyl group is substituted with an alkali metal,
the metal sheet not containing the metal to be deposited.

2. An electrolyte according to claim 1, wherein the aromatic compound has at least one kind from the group consisting of a hydroxyl group and a group in which hydrogen in a hydroxyl group is substituted with an alkali metal, and has at least one kind from the group consisting of a hydrogen atom and an alkyl group having a carbon number of 1 to 10,
the former kind being bonded to aromatic ring at each of two positions where hydrogen atoms are bondable,
the latter kind being bonded to aromatic ring at each of the remaining positions where hydrogen atoms are bondable.

3. An anode comprising:
a metal sheet which is a precipitation substrate for depositing metal and does not contain the metal to be deposited; and
a precipitation film made of a precipitate which is formed when depositing the metal on the metal sheet in an electrolytic solution containing an aromatic compound having at least one kind from a hydroxyl group and a group in which hydrogen in a hydroxyl group is substituted with an alkali metal.

4. An anode according to claim 3, wherein the aromatic compound has at least one kind from the group consisting of a hydroxyl group and a group in which hydrogen in a hydroxyl group is substituted with an alkali metal, and has at least one kind from the group consisting of a hydrogen atom and an alkyl group having a carbon number of 1 to 10,
the former kind being bonded to aromatic ring at each of two positions where hydrogen atoms are bondable,
the latter kind being bonded to aromatic ring at each of the remaining positions where hydrogen atoms are bondable.

5. An anode according to claim 3, wherein the metal to be deposited is lithium (Li).

6. A battery comprising:
a cathode;
an anode; and
an electrolyte,
wherein the electrolyte has a precipitate which is formed when depositing metal on a metal sheet in an electrolytic solution containing an aromatic compound having at least one kind from a hydroxyl group and a group in which hydrogen in a hydroxyl group is substituted with an alkali metal,
the metal sheet not containing the metal to be deposited.

7. A battery according to claim 6, wherein the aromatic compound has at least one kind from the group consisting of a hydroxyl group and a group in which hydrogen in a hydroxyl group is substituted with an alkali metal, and has at least one kind from the group consisting of a hydrogen atom and an alkyl group having a carbon number of 1 to 10,
the former kind being bonded to aromatic ring at each of two positions where hydrogen atoms are bondable,
the latter kind being bonded to aromatic ring at each of the remaining positions where hydrogen atoms are bondable.

8. A battery comprising:
a cathode;
an anode; and
an electrolyte,
wherein the anode comprises a metal sheet which is a precipitation substrate for depositing metal and does not contain the metal to be deposited and a precipitation film made of a precipitate formed when depositing the metal on the metal sheet in an electrolytic solution containing an aromatic compound having at least one kind from a hydroxyl group and a group in which hydrogen in a hydroxyl group is substituted with an alkali metal.

9. A battery according to claim 8, wherein the aromatic compound has at least one kind from the group consisting of a hydroxyl group and a group in which hydrogen in a hydroxyl group is substituted with an alkali metal, and has at least one kind from the group consisting of a hydrogen atom and an alkyl group having a carbon number of 1 to 10,
the former kind being bonded to aromatic ring at each of two positions where hydrogen atoms are bondable,
the latter kind being bonded to aromatic ring at each of the remaining positions where hydrogen atoms are bondable.

10. A battery according to claim 8, wherein the metal to be deposited is lithium (Li).
